(19) United States
(12) Patent Application Publication
(10) Pub. No.: US 2022/0168889 A1
(43) Pub. Date: Jun. 2, 2022

(54) AUTOMATED DISPLACEMENT AND TURNOVER SYSTEM AND DEVICE THEREOF

(71) Applicant: Yi-Nan CHO, TAICHUNG CITY (TW)

(72) Inventor: Yi-Nan CHO, TAICHUNG CITY (TW)

(21) Appl. No.: 17/529,242

(22) Filed: Nov. 17, 2021

(30) Foreign Application Priority Data
Dec. 1, 2020 (TW) 109142177

(51) Int. Cl. B25J 9/10; B25J 17/00; A47J 37/07

(52) U.S. Cl. CPC B25J 9/105; B25J 17/00; B25J 9/104; B25J 9/102; A47J 37/0745

(57) ABSTRACT

The invention provides an automated displacement and turnover system and a device thereof. The device comprises a base, a stroke control mechanism disposed on the base, a fixture mounting seat, and a processing fixture assembled on the fixture mounting seat; the stroke control mechanism is in driving connection with the fixture mounting seat, so that the processing fixture is driven by the stroke control mechanism to perform cyclic actions of fixed-point processing at a processing position, linear displacement to a turnover position, fixed-point turning at the turnover position, and linear displacement to the processing position until a processing procedure is completed and an object of automated turnover and processing is realized. In addition, the device is used with a terminal device and a mobile terminal to form an automated displacement and turnover system.

### BACKGROUND OF THE INVENTION

### Field of Invention

The invention relates to mechanical equipment, and more particularly to an automated displacement and turnover system and a device thereof with functions of driving a workpiece to perform linear displacement and fixed-point turnover.

### Description of Related Art

In the fields of cooking, detection and inspection, and workpiece processing, it is often required to process flat or flat plate-shaped objects to be processed after being turned 180° to 360°. In the cookery field, such as baking sponge cakes and grilling ingredients, it is necessary to turn the baking mold or ingredient to ensure uniform heating; in the detection and inspection field, plate-shaped objects such as wafers, double-sided sprayed plates, etc., need to be turned over for quality detection and inspection; and in the processing field, when plate-shaped objects require double-sided spraying, they need to be turned over to spray the upper and lower surfaces of the processed objects.

It is particularly worth noting that in the field of cooking, baking mold or ingredient is turned over and heated by manual operation, which is likely to affect the final cooking quality and production efficiency due to lack of experience or other human factors. Therefore, there are currently many devices that are used to turn and heat the ingredient fixing and heating tool such as baking mold, skewer or grill at fixed points.

However, in the currently known technical solutions, even if the barbecue grill has the function of lifting and turning over the ingredient fixing and heating tool (such as grilling net), it can only be operated manually, which is likely to cause the problem of unstable cooking quality and labor-consuming; therefore, the barbecue grill that can be automatically turned over and heated is provided by connecting and driving the rotating shaft, the sprocket, the gear, and the chain driving mechanisms of the ingredient fixing and heating tool (grilling net or skewer). But in these technical solutions, the design of the linkage driving mechanisms for turnover and heating actions will make the ingredient fixing and heating tool virtually without the function of lifting operation, or the ingredient fixing and heating tool can be manually operated to be lifted upward but will be disconnected with the driving mechanisms for automatic turnover due to being lifted, and therefore cannot achieve both the lifting and turnover functions.

It is also worth noting that the aforementioned known technical solutions can only be used in the cooking field, and it is difficult to meet the demands of the detection and inspection field and the workpiece processing field that require processing after turnover.

### SUMMARY OF THE INVENTION

In order to overcome the above technical problems, an object of the invention is to provide an automated displacement and turnover system and a device thereof capable of automatically displacing and turning a processing fixture to save manpower through the automated displacement and turnover device with linear displacement and fixed-point turnover functions. In addition, the automated displacement and turnover device is capable of communicating with a terminal device and/or a mobile device through line communication or wireless communication to form the automated displacement and turnover system, thereby achieving automated control, improving processing quality and efficiency, and wide application fields.

In order to achieve the above object, the invention provides an automated displacement and turnover device comprising a base; a stroke control mechanism disposed on the base, the stroke control mechanism has a power source for driving; a fixture mounting seat provided on the base and in driving connection with the stroke control mechanism to be driven by the power source to perform linear displacement; and a processing fixture assembled on the fixture mounting seat and performing linear displacement along with the fixture mounting seat; the automated displacement and turnover device has two positions corresponding to two terminals of linear displacement of the fixture mounting seat, the two positions are defined as a processing position and a turnover position respectively; the processing fixture is driven by the stroke control mechanism to perform cyclic actions of fixed-point processing at the processing position, linear displacement to the turnover position, fixed-point turning at the turnover position, and linear displacement to the processing position until completing a processing procedure.

The invention further provides an automated displacement and turnover system comprising the automated displacement and turnover device, and a terminal device and/or a mobile terminal; wherein the automated displacement and turnover device comprises a device body and a processing fixture installed on the device body; the terminal device and the mobile terminal are used to connect to the device body through communication, and a control module is provided to control and drive the device body to perform linear displacement and fixed-point turnover functions in preset mode.

Regarding the techniques, means and other efficacies adopted by the invention to achieve the above-mentioned object, preferred and feasible embodiments are described in detail in conjunction with the drawings as follows.

### BRIEF DESCRIPTION OF THE DRAWINGS

FIG. 1 is a perspective structural view of an automated displacement and turnover device of the invention;

FIG. 2 is a side structural view of the automated displacement and turnover device of the invention;

FIG. 3 is a top structural view of the automated displacement and turnover device of the invention;

FIGS. 4A to 4D are schematic diagrams of positions of a sliding seat traction turntable of the automated displacement and turnover device of the invention that rotates 90° each time in a clockwise direction to drive linear displacement of a sliding seat;

FIG. 5 is a schematic diagram of a first use mode of the automated displacement and turnover device of the invention;

FIG. 6 is a schematic diagram of a second use mode of the automated displacement and turnover device of the invention;

FIG. 7 is a schematic diagram of a third use mode of the automated displacement and turnover device of the invention;

FIG. 8 is a schematic diagram of a fourth use mode of the automated displacement and turnover device of the invention;

FIG. 9 is a schematic diagram of a use state of the automated displacement and turnover device of the invention for fixing with a grilling net fixture for grilling;

FIG. 10 is a schematic diagram of a use state of the automated displacement and turnover device of the invention for fixing with a plate-shaped fixture for processing;

FIG. 11 is a schematic diagram of a structure of an automated displacement and turnover system of the invention; and

FIG. 12 shows actions of the automated displacement and turnover device of the invention.

### DETAILED DESCRIPTION OF THE INVENTION

In order to facilitate the understanding of the invention, the following description is provided in conjunction with the embodiments.

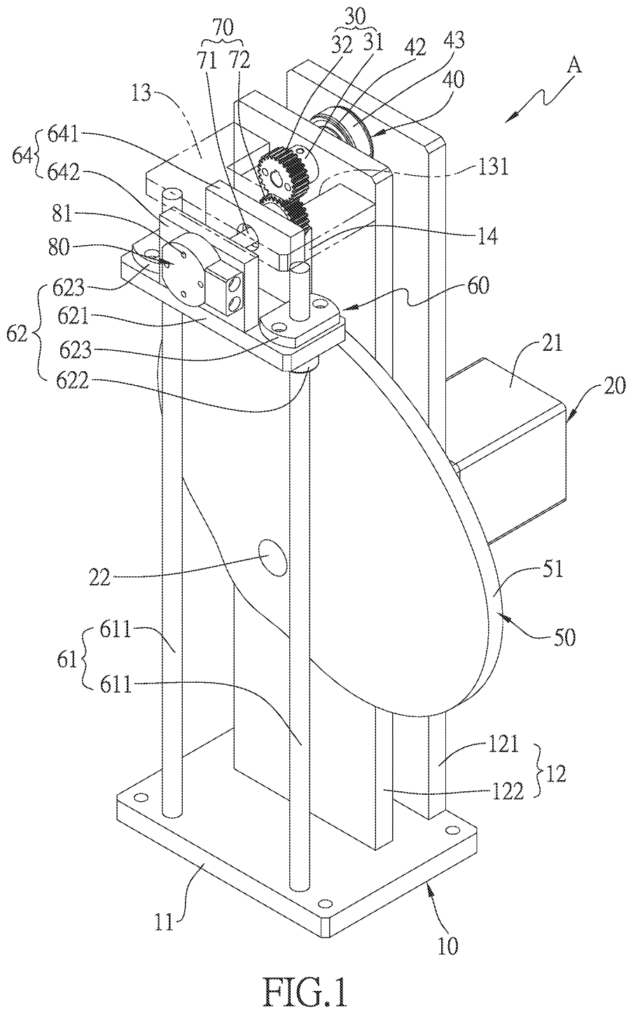

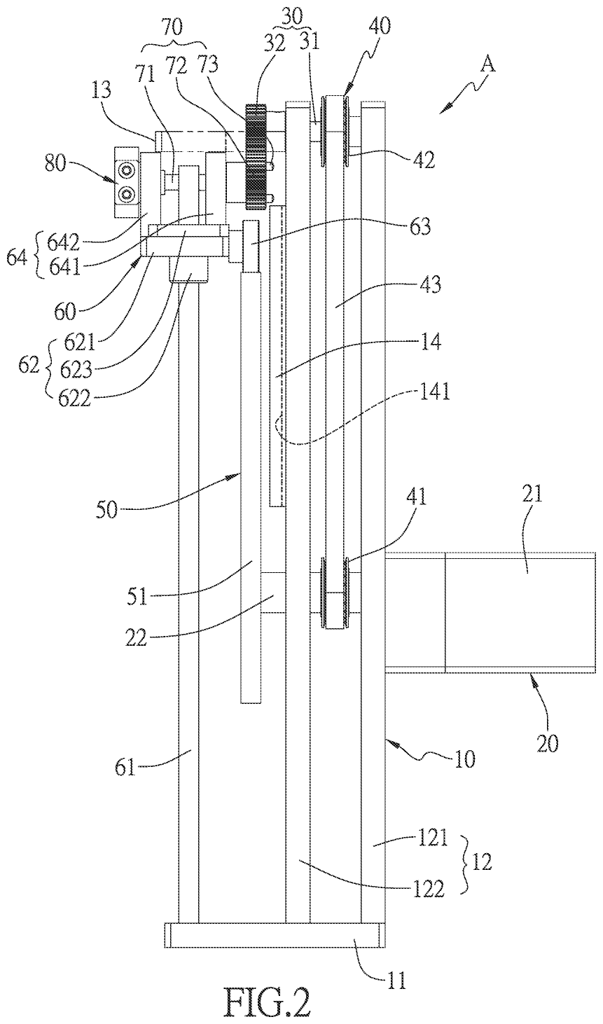

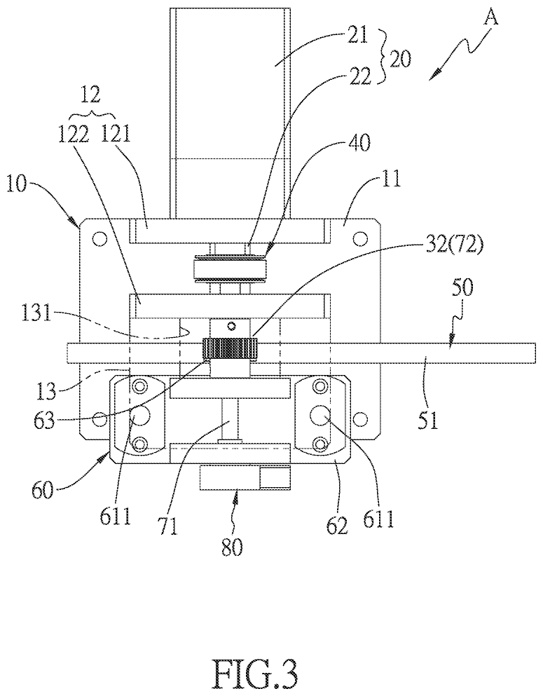

As shown in FIGS. 1 to 4A, an automated displacement and turnover device A of the invention comprises a base 10, a stroke control mechanism provided on the base 10, a fixture mounting seat 80, and a processing fixture 90; wherein, the stroke control mechanism further comprises a driving mechanism 20, a driving gear set 30, a belt transmission assembly 40, a disc cam 50, and a driven gear set 70 in driving connection with the fixture mounting seat 80 and the processing fixture 90 to drive the fixture mounting seat 80 and the processing fixture 90 to perform linear displacement and fixed-point turnover.

Wherein, as shown in FIGS. 1 and 2, the base 10 comprises a base plate 11 and a mounting frame 12 vertically disposed on a surface of the base plate 11. The mounting frame 12 has a first back plate 121 and a second back plate 122 disposed at intervals. A surface of the second back plate 122 facing away from the first back plate 121 is provided with a baffle 13 and a rotation-limiting groove rail 14, the rotation-limiting groove rail 14 is disposed along a length direction of the second back plate 122 and provided with an elongated slot 141, and the rotation-limiting groove rail 14 is provided for cooperating with the driven gear set 70 so that the driven gear set 70 can be locked and limited from moving or unlocked to rotate. In one embodiment of the invention, the baffle 13 is provided with a gear accommodating port 131 at a position adjacent to the second back plate 122, the gear accommodating port 131 is provided for accommodating the driving gear set 30, so that when the baffle 13 is disposed as a displacement terminal of a linear sliding assembly 60, increase in an overall volume of the automated displacement and turnover device A caused by the driving gear set 30 and the driven gear set 70 due to insufficient space can be avoided.

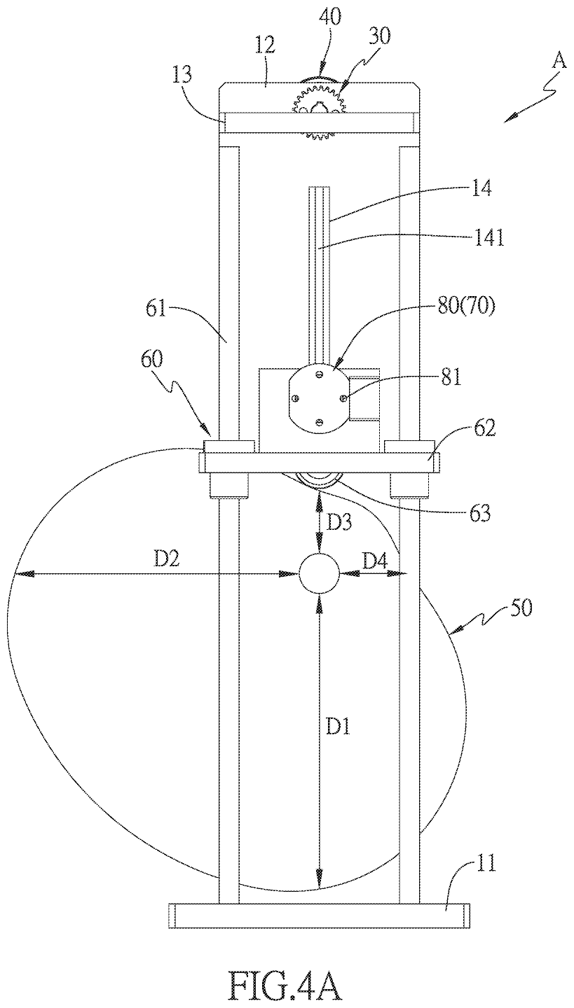

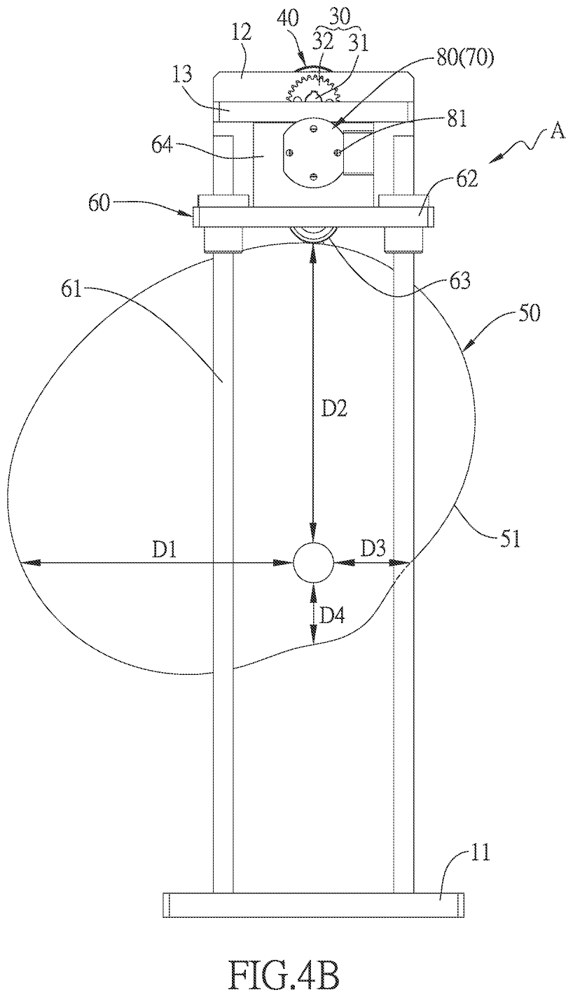

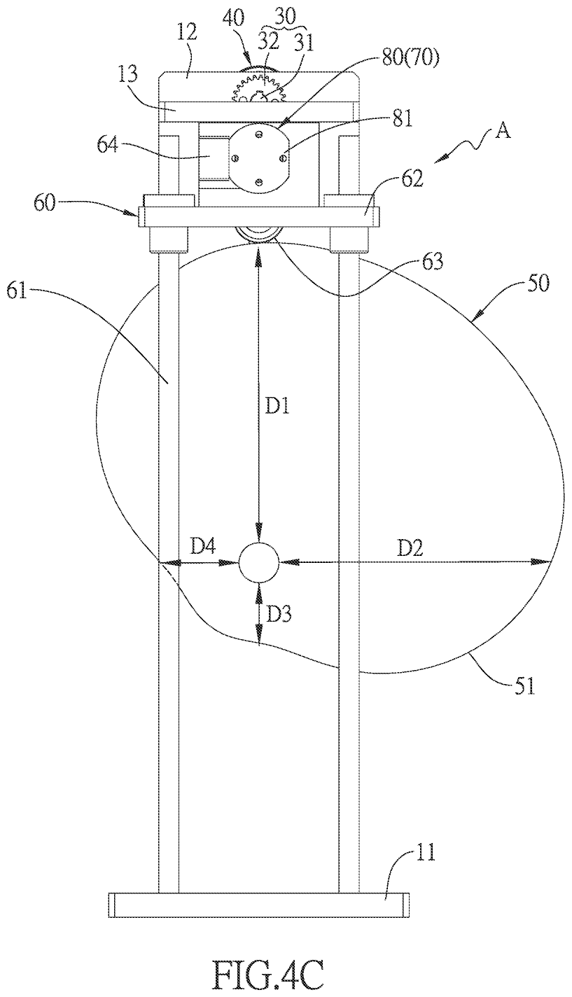

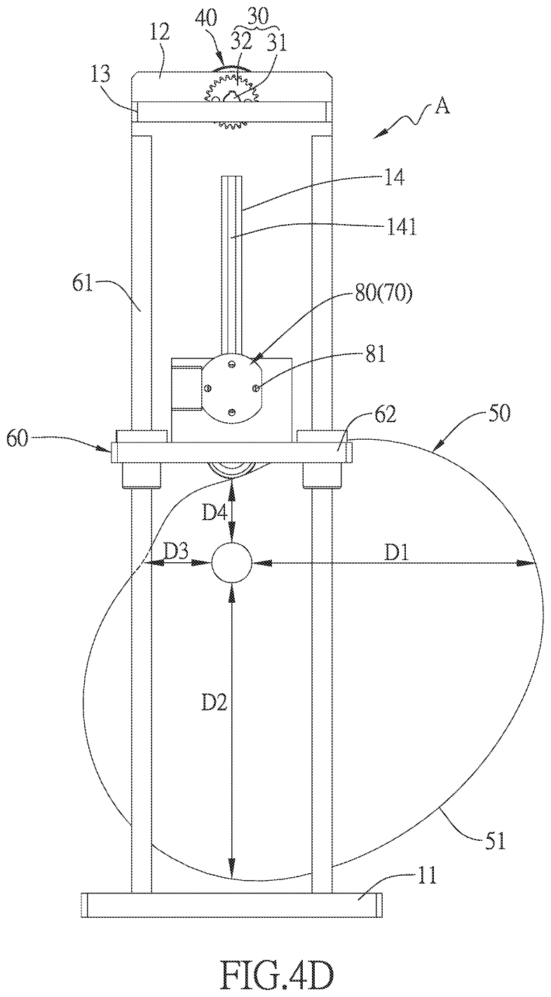

As shown in FIGS. 1, 2, and 3, the driving mechanism 20 comprises a power source 21 and a transmission shaft 22 driven by the power source 21; the power source 21 is disposed on a surface of the first back plate 121 facing away from the second back plate 122, and the transmission shaft 22 rotatably penetrates the first back plate 121 and the second back plate 122. The disc cam 50 is a cam member with a geometrically closed contour peripheral surface 51, the transmission shaft 22 is eccentrically connected to the disc cam 50; as shown in FIG. 4A, the disc cam 50 uses the transmission shaft 22 as its circle center and has changes in radius lengths D1, D2, D3, D4 along a clockwise direction. Wherein, the radius length D1 has a length the same as that of the radius length D3, and is the maximum radius length of the disc cam 50, and the radius length D2 has a length the same as that of the radius length D4, and is the minimum radius length of the disc cam 50; the disc cam 50 causes the linear sliding assembly 60 assembled with the disc cam 50 to be drawn for linear displacement through changes in the radius length.

As shown in FIGS. 1, 2, and 3, the mounting frame 12 is provided with the driving gear set 30 on an end portion away from the base plate 11, the driving gear set 30 comprises a driving shaft 31 rotatably penetrating the first back plate 121 and the second back plate 122, one end of the driving shaft 31 is rotatably connected with the first back plate 121, and another end of the driving shaft 31 is fixedly connected to a driving gear 32.

As shown in FIGS. 1, 2, and 3, the belt transmission assembly 40 is further provided between the first back plate 121 and the second back plate 122. The belt transmission assembly 40 comprises a first pulley 41, a second pulley 42 and a belt 43, the first pulley 41 is fixedly sleeved on the transmission shaft 22, the second pulley 42 is fixedly sleeved on the driving shaft 31 of the driving gear set 30, and the belt 43 is wound around the first pulley 41 and the second pulley 42, so that the driving shaft 31 of the driving gear set 30 is in driving connection with the power source 21 of the driving mechanism 20 through the belt transmission assembly 40. Thereby, the power source 21 drives the transmission shaft 22 to rotate, the driving gear set 30 is driven by the belt transmission assembly 40 to rotate the driving gear 32, and the disc cam 50 rotates with rotation of the transmission shaft 22.

As shown in FIGS. 1, 2, and 3, the linear sliding assembly 60 comprises a sliding rail 61 and a sliding seat 62. The sliding rail 61 is located by a side of the second back plate 122 away from the first back plate 121 and is vertically disposed between the base plate 11 and the baffle 13, the sliding rail 61 is composed of two rods 611 disposed in parallel; opposite ends of the sliding seat 62 are penetrated by the two rods 611 to be slidably mounted on the sliding rail 61, the sliding seat 62 has a bottom plate 621, the sliding seat 62 is sleeved and slidably disposed on the two rods 611 through mounting bearings 622 at two ends of the bottom plate 621 respectively, and the two ends of the bottom plate 621 are further provided with reinforcements 623 respectively to thicken the bottom plate 621 and reinforce a structural strength of sliding assembly between the bottom plate 621 and the rod 611.

As shown in FIG. 2, the sliding seat 62 of the linear sliding assembly 60 is provided with a driven pulley 63 on a side of the bottom plate 621 facing the first back plate 121, the sliding seat 62 abuts against the peripheral surface 51 of the disc cam 50 through the driven pulley 63 in order to use changes in the radius length of the disc cam 50 to draw and drive the sliding seat 62 to slide along the sliding rail 61, thereby realizing linear displacement function of the automated displacement and turnover device A of the invention.

As shown in FIGS. 1, 2, and 3, the bottom plate 621 of the sliding seat 62 is further provided with an assembly component 64 on a surface facing the baffle 13. In one embodiment of the invention, the assembly component 64 comprises a first plate 641 and a second plate 642 vertically disposed and spaced apart from each other. The driven gear set 70 is mounted on the assembly component 64, the driven gear set 70 comprises a relay shaft 71 that rotatably penetrates the first plate 641 and the second plate 642, one end of the relay shaft 71 is fixedly connected with a driven gear 72, and another end of the relay shaft 71 is fixedly disposed on the fixture mounting seat 80. In one embodiment of the invention, the fixture mounting seat 80 is provided with a plurality of screw holes 81 for screw-locking and assembling with the processing fixture 90.

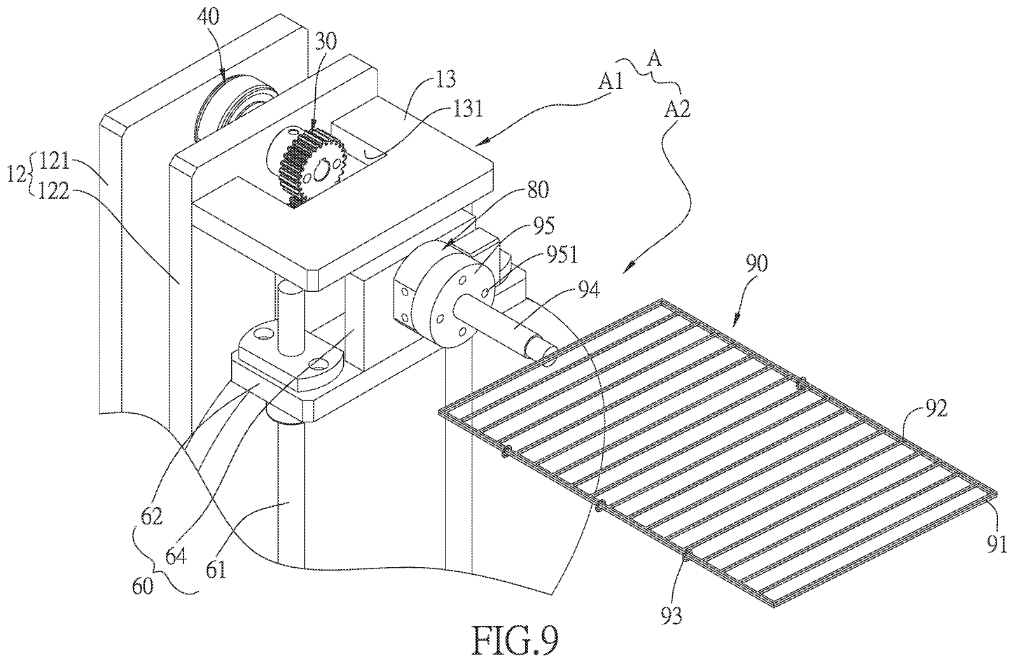

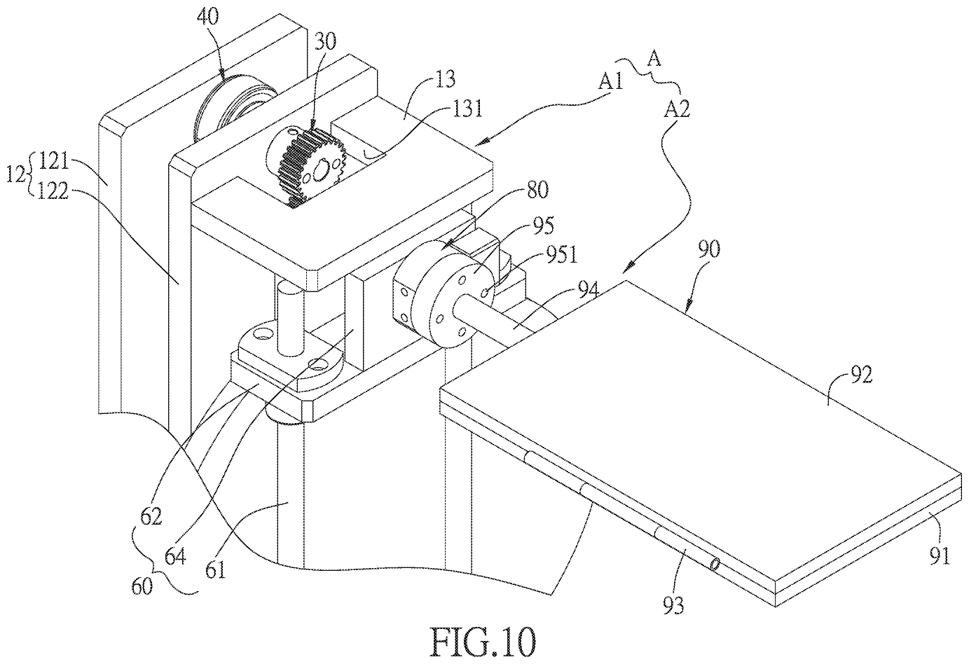

As shown in FIGS. 9 and 10, the processing fixture 90 is assembled through the fixture mounting base 80 to be driven by the automated displacement and turnover device A to realize displacement and turnover operations. The processing fixture 90 comprises a fixture body composed of a first fixture portion 91, a second fixture portion 92 and a pivoting portion 93, and an adapter structure composed of a connecting rod 94 and an adapter seat 95. Wherein, the first fixture portion 91 and the second fixture portion 92 are pivotally connected by the pivoting portion 93 to form a flat or flat plate-shaped fixture mechanism that can be turned and opened to place objects or overlapped to clamp objects. Specifically, the first fixture portion 91 and the second fixture portion 92 can be a mesh, a flat plate cover, a mold, or a flat plate-shaped frame to clamp an object to be processed (heating, spraying, or detection and inspection) according to application requirements. One end of the connecting rod 94 of the processing fixture 90 is fixedly connected to the first fixture portion 91, and another end of the connecting rod 94 is fixedly connected to the adapter seat 95. The adapter seat 95 is formed as a block with a shape the same as or similar to that of the fixture mounting seat 80, and lock holes 951 with a quantity and positions corresponding to that of the screw holes 81 are provided on the adapter seat 95, so that the processing fixture 90 can be fixedly assembled to the fixture mounting seat 80 through screw lock elements (not shown in the figures) penetrating the lock holes 951 and then locking with the screw holes 81.

As shown in FIGS. 1, 2 and 4A to 4D, it is defined that the sliding seat 62 is located at a first position when in contact with the peripheral surface 51 of the disc cam 50 having the shortest radius length, and it is defined that the sliding seat 62 is located at a second position when in contact with the peripheral surface 51 of the disc cam 50 having the longest radius length; two terminals of a linear displacement distance of the fixture mounting seat 80 are a first terminal and a second terminal, it is defined that a position at which the automated displacement and turnover device A corresponding to the first terminal is a processing position, it is defined that a position at which the automated displacement and turnover device A corresponding to the second terminal is a turnover position, and the processing position is the same as the first position of the sliding seat 62, and the turnover position is the same as the second position of the sliding seat 62.

In one embodiment of the invention, as shown in FIG. 2, the driven gear 72 of the driven gear set 70 is provided with two position-limiting protrusions 73 on a surface facing the first back plate 121, and the two position-limiting protrusions 73 are used to cooperate with the rotation-limiting groove rail 14. During linear displacement of the driven gear set 70 driven by the sliding seat 62, the two position-limiting protrusions 73 are accommodated in the elongated slot 141 to achieve a locking effect to prevent the driven gear set 70 from rotating and shaking, which affects a stability of combination between the processing fixture 90 and the fixture mounting seat 80. When the sliding seat 62 moves to the turnover position, the position-limiting protrusions 73 of the driven gear set 70 will first detach from the elongated slot 141 of the rotation-limiting groove rail 14 to form an unlocked state, and then the driven gear 72 is meshed with the driving gear 32 and driven to rotate, thereby driving the processing fixture 90 to perform a 180° turnover action.

In one embodiment of the invention, between the transmission shaft 22 and the first back plate 121 and/or the second back plate 122, between the driving shaft 31 and the first back plate 121 and the second back plate 122, and between the relay shaft 71 and the first plate 641 and the second plate 642, a bearing element can be provided to realize rotational connection.

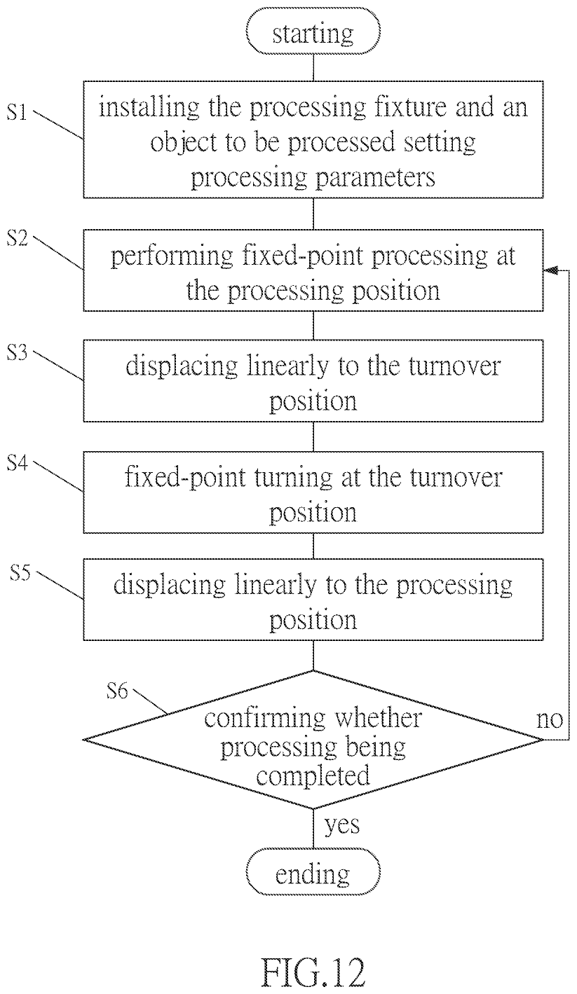

As shown in FIGS. 4A to 4B and FIG. 12, cyclic operation steps of the automated displacement and turnover device A of the invention comprise:

installation and setting step S1: installing the processing fixture 90 and an object to be processed on the fixture mounting seat 80, and setting processing parameters according to processing requirements;

fixed-point processing step S2: according to the processing parameters, making the processing fixture 90 to stay at the processing position to perform fixed-point processing, as shown in FIG. 4A, a schematic diagram showing that the fixture mounting seat 80 (equivalent to the position of the processing fixture 90) is located at the processing position;

first linear displacement step S3: according to the processing parameters, driving the stroke control mechanism to linearly displace the processing fixture 90 to the turnover position, as shown in FIG. 4B, a schematic diagram showing that the fixture mounting seat 80 (equivalent to the position of the processing fixture 90) is located at the turnover position after the disc cam 50 is rotated by 90°;

fixed-point turnover step S4: through control of the stroke control mechanism, displacing the fixture mounting seat 80 to the turnover position and at the same time performing 180° turnover, as shown in FIG. 4C, a state diagram showing that the disc cam 50 is further rotated by 90°, and the fixture mounting seat 80 has been turned by 180° after reaching the turnover position;

second linear displacement step S5: through control of the stroke control mechanism, linearly displacing the overturned processing fixture 90 back to the processing position, FIG. 4D shows that the disc cam 50 is further rotated by 90°, and the fixture mounting seat 80 has been drawn back to the initial processing position by the disc cam 50; and

processing completion judging step S6: according to the processing parameters, confirming whether processing being completed, if processing being completed, ending actions; if processing being not completed, repeating the fixed-point processing step S2 to the processing completion judging step S6 cyclically until completing processing.

The automated displacement and turnover device A of the invention drives the belt transmission assembly 40 to drive the driving gear set 30 to rotate and drive the disc cam 50 to rotate through the driving mechanism 20, and then uses the driven pulley 63 to contact the peripheral surface 51 of the disc cam 50 with the varying radius lengths and slide along the peripheral surface 51 to realize drawing the sliding seat 62 to perform linear displacement along the sliding rail 61, and when the sliding seat 62 is displaced to the turnover position, the driven gear set 70 is meshed with the driving gear set 30 and turned over 180°, and then uses the varying radius lengths of the disc cam 50, the driven gear set 70 is retracted from the driving gear set 30 while turning over 180° and then locked with the rotation-limiting groove rail 14.

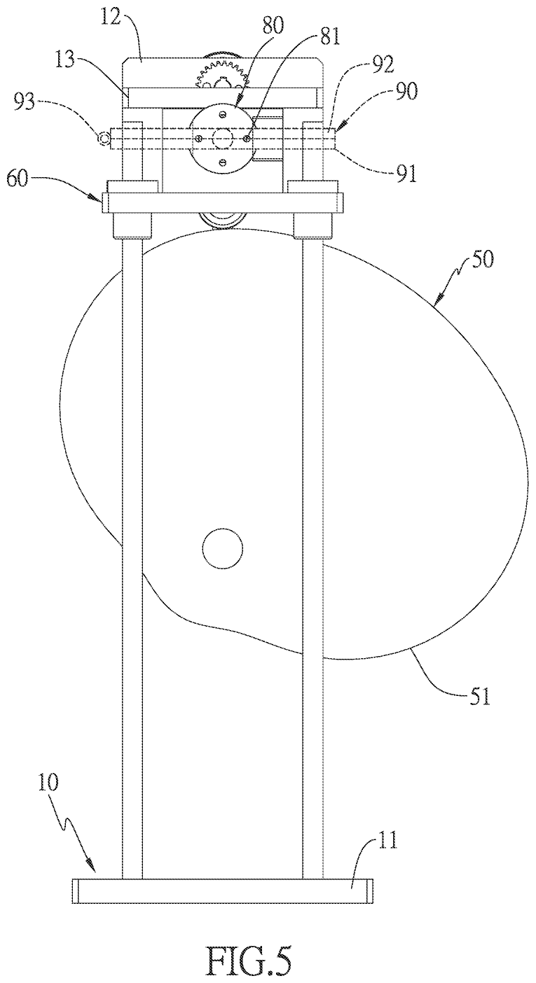

The automated displacement and turnover device A of the invention can be applied to the fields which often require to process flat or flat plate-shaped objects to be processed after being turned 180° according to use requirements, such as cooking field, detection and inspection field or workpiece processing field; therefore, the automated displacement and turnover device A of the invention can be used uprightly as shown in FIG. 5, using the base plate 11 as a bottom supporting plate of the device A, so that the sliding seat 62 is linearly displaced by ascending upward and descending downward, and the processing position is formed at a lower part of the device A and the turnover position is formed at an upper part of the device A.

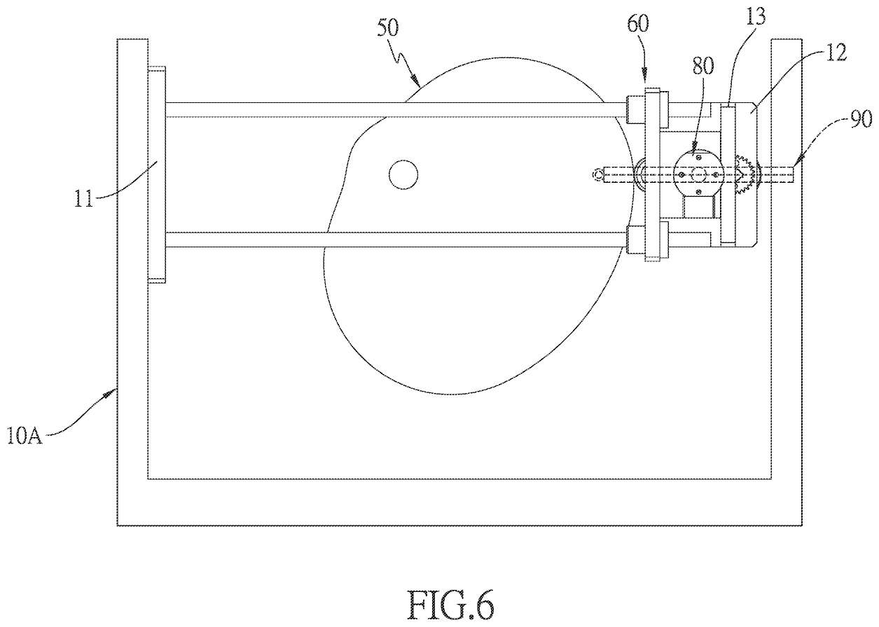

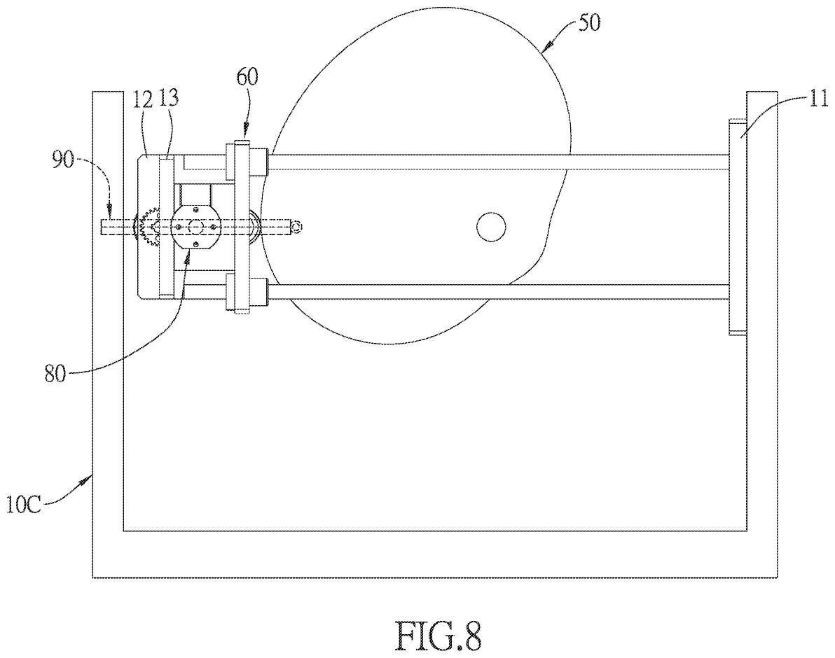

Or, as shown in FIGS. 6 and 8, roughly U-shaped bases 10a, 10c are provided, and the base plate 11 is provided on an inner surface of a side plate of the bases 10a, 10c, so that the device A of the invention is used horizontally. The sliding seat 62 is caused to perform lateral and horizontal linear displacement, the processing position is formed at an end of the device A where the base plate 11 is provided, and the turnover position is formed at an end of the device A where the driving gear set 30 is provided.

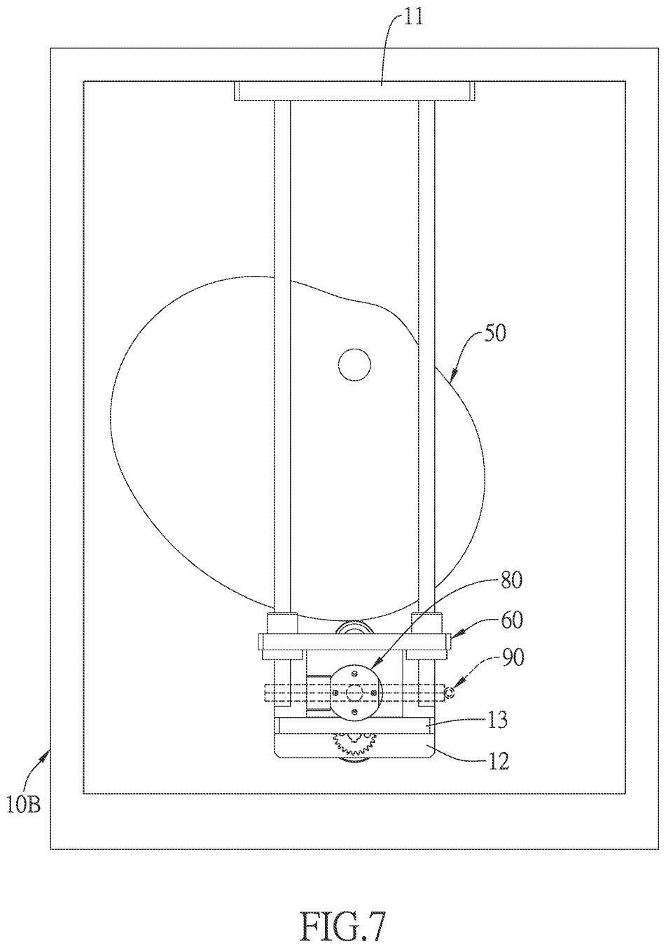

Or, as shown in FIG. 7, a frame-shaped base 10b is provided, and the base plate 11 is disposed on an inner surface of a top plate of the base 10b, so that the device A of the invention is used vertically. The sliding seat 62 is caused to perform linear displacement by ascending upward and descending downward, the processing position is formed at an end of the device A where the base plate 11 is provided, and the turnover position is formed at an end of the device A where the driving gear set 30 is provided.

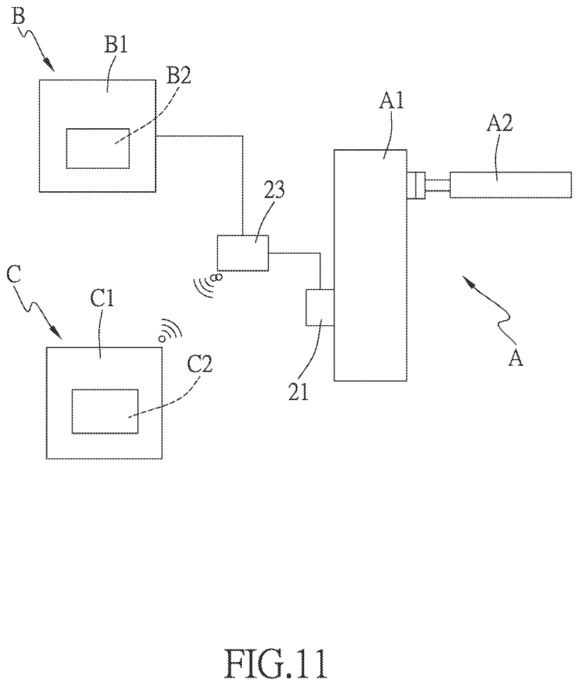

The invention provides an automated displacement and turnover system and a device thereof. As shown in FIG. 11, the automated displacement and turnover system comprises the automated displacement and turnover device A, a terminal device B, and/or a mobile terminal C. Wherein, the automated displacement and turnover device A mainly comprises a device body A1 and a processing fixture A2. The device body A1 is a turnover device with automated linear displacement and fixed-point turnover functions. The processing fixture A2 is used to be installed on the device body A1 to be driven to realize an object of automated displacement and turnover. The terminal device B and the mobile terminal C are used to connect to the device body A1 through communication, and the device body A1 is controlled and driven to perform linear displacement and fixed-point turnover functions in preset mode; specifically, the terminal device B can be a computer or a computer system, the terminal device B mainly comprises a terminal body B1 and a control module B2 disposed inside the terminal body B 1; the mobile terminal C can be a mobile device such as mobile phone, notebook computer, tablet computer, POS machine, and on-board computer, the mobile terminal C mainly comprises a terminal body C1 and a control module C2 disposed inside the terminal body C1.

In one embodiment of the invention, communication connection between the automated displacement and turnover device A and the terminal device B and the mobile terminal C comprises wired communication connection and wireless communication connection, and the wireless communication connection can comprise Bluetooth communication connection or WIFI communication connection. In addition, the power source 21 of the device A of the invention can be further connected with an intelligent control module 23 to cooperate with the terminal device B and the mobile terminal C to form an intelligent control device.

Further, when the automated displacement and turnover device A of the invention is used, it can cooperate with the control modules B2, C2 provided in the terminal device B and/or the mobile terminal C to perform parameter setting and/or remote control, for example, a control APP (the control module C2) is installed in a mobile phone, through wireless communication or wired communication, connect the APP to the intelligent control module 23 provided in the automated displacement and turnover device A, and then the automated displacement and turnover device A can be remotely controlled to perform an object of grilling food.

Therefore, the automated displacement and turnover device A of the invention realizes linear displacement and 180° fixed-point turnover functions through cooperation between the disc cam 50, the driving gear set 30, the driven gear set 70 and the linear sliding assembly 60; and when being used in conjunction with the terminal device B and the mobile terminal C, the automated displacement and turnover device A is capable of setting stay time at work position according to a user's setting to achieve objects of automatic turnover and processing, saving manpower and ensuring quality.

In summary, the invention is capable of effectively solving the drawbacks of the prior art, and can be easily understood and implemented by those having ordinary skill in the art to which the invention pertains. However, the above description is only the preferred embodiments of the invention, and should be construed as exemplary rather than as limitative of the invention, with many variations and modifications being readily attainable by a person of average skill in the art without departing from the spirit or scope thereof as defined by the appended claims and their legal equivalents.

What is claimed is:

1. An automated displacement and turnover device comprising:
a base;
a stroke control mechanism disposed on the base, the stroke control mechanism having a power source for driving;
a fixture mounting seat provided on the base and in driving connection with the stroke control mechanism to be driven by the power source to perform linear displacement; and
a processing fixture assembled on the fixture mounting seat and performing linear displacement along with the fixture mounting seat;
the automated displacement and turnover device having two positions corresponding to two terminals of linear displacement of the fixture mounting seat, defining the two positions as a processing position and a turnover position respectively;
the processing fixture being driven by the stroke control mechanism to perform cyclic actions of fixed-point processing at the processing position, linear displacement to the turnover position, 180° fixed-point turning at the turnover position, and linear displacement to the processing position until completing a processing procedure.

2. The automated displacement and turnover device as claimed in claim 1, wherein the stroke control mechanism comprises a driving mechanism, a driving gear set, a belt transmission assembly, a disc cam, a linear sliding assembly and a driven gear set; the driving mechanism comprises the power source and a transmission shaft driven by the power source, the driving mechanism drives the driving gear set and the disc cam to rotate through transmission of the transmission shaft; the driving gear set is disposed above the turnover position corresponding to the base, the disc cam is disposed below the processing position corresponding to the base, the disc cam is eccentrically connected to the transmission shaft, a peripheral surface of the disc cam uses the transmission shaft as an axis to form a geometrically closed contour with varying radius lengths; the linear sliding assembly comprises a sliding rail and a sliding seat, the sliding rail is disposed on a same side with the driving gear set and the disc cam, the sliding seat is slidably disposed on the sliding rail and abuts against the peripheral surface of the disc cam in order to use changes in the radius length of the disc cam to displace linearly between the processing position and the turnover position as the disc cam rotates; the driven gear set is rotatably disposed on the sliding seat and linearly displaced with the sliding seat; and the fixture mounting seat is fixedly connected to the driven gear set and rotates or displaces linearly with the driven gear set to drive the processing fixture to move simultaneously.

3. The automated displacement and turnover device as claimed in claim 2, wherein:
the base comprises a base plate, a mounting frame and a baffle, the base plate is fixedly connected to an end surface of one end of the mounting frame, the baffle is disposed on a side surface of another end of the mounting frame;
the driving mechanism comprises the power source fixedly disposed on a side surface of the mounting frame, the power source has the transmission shaft rotatably penetrating the mounting frame;
the driving gear set is disposed at an end portion of the other end of the mounting frame, the belt transmission assembly is provided for transmission connection between the driving gear set and the transmission shaft of the driving mechanism;
the linear sliding assembly has the sliding rail fixedly disposed between the base plate and the baffle of the base, the sliding seat is slidably provided on the sliding rail, a side surface of the sliding seat facing the mounting frame is provided with a driven pulley, the driven pulley abuts against the peripheral surface of the disc cam and uses changes in the radius length of the disc cam to be abutted against and pushed by the disc cam to displace linearly along the sliding rail; the sliding seat is further provided with an assembly component thereon;
the driven gear set comprises a relay shaft and a driven gear, the relay shaft rotatably penetrates the assembly component along an axial direction of a driving shaft of the driving gear set, one end of the relay shaft is fixedly connected to the driven gear, another end of the relay shaft is fixedly disposed on the fixture mounting seat to assemble with the processing fixture;
thereby, the automated displacement and turnover device drives the disc cam and the belt transmission assembly to move through the driving mechanism, and drives the driving gear set to rotate by the belt transmission assembly, and then uses the disc cam to draw and drive the sliding seat to displace linearly along the sliding rail, and when the driven pulley abuts against the peripheral surface at a position with a largest radius length, the sliding seat drives the driven gear set to mesh with the driving gear set at the turnover position, so as to continue to rotate with the disc cam to make the driven gear set rotate to drive the fixture mounting seat and the processing fixture to turn over 180°, and then uses the varying radius lengths of the disc cam, the driven gear set is retracted from the driving gear set while turning over at a fixed point, and when the driven pulley abuts against the peripheral surface at a position with a smallest radius length, the sliding seat drives the driven gear set back to the processing position for processing.

4. The automated displacement and turnover device as claimed in claim 3, wherein:
the mounting frame has a first back plate and a second back plate disposed at intervals, a surface of the second back plate facing away from the first back plate is further provided with a rotation-limiting groove rail, the rotation-limiting groove rail is disposed along a length direction of the second back plate and provided with an elongated slot;
the driven gear of the driven gear set is provided with two position-limiting protrusions on a surface facing the mounting frame;
when the sliding seat is located at the turnover position, the driven gear set meshes with the driving gear set, and the two position-limiting protrusions retract from the elongated slot of the rotation-limiting groove rail to unlock and cause the driven gear set to rotate; after the sliding seat leaves the turnover position, the driven gear set retracts from the driving gear set, and the two position-limiting protrusions are inserted into the elongated slot of the rotation-limiting groove rail and displace along the elongated slot to reach the processing position to lock the driven gear set and prevent the driven gear set from rotating.

5. The automated displacement and turnover device as claimed in claim 1, wherein the processing fixture comprises a fixture body and an adapter structure, and the processing fixture is locked and assembled with the fixture mounting seat by screws through the adapter structure.

6. The automated displacement and turnover device as claimed in claim 5, wherein the fixture mounting seat is provided with a plurality of screw holes; the processing fixture comprises a fixture body composed of a first fixture portion, a second fixture portion and a pivoting portion, and an adapter structure composed of a connecting rod and an adapter seat; the first fixture portion and the second fixture portion are pivotally connected by the pivoting portion to form a flat or flat plate-shaped fixture mechanism that can be turned and opened to place objects or overlapped to clamp objects; one end of the connecting rod is fixedly connected to the first fixture portion, another end of the connecting rod is fixedly connected to the adapter seat, lock holes with a quantity and positions corresponding to that of the screw holes of the fixture mounting seat are provided on the adapter seat; and the processing fixture is assembled to the fixture mounting seat through screw lock elements penetrating the lock holes and then locking with the screw holes.

7. The automated displacement and turnover device as claimed in claim 6, wherein the first fixture portion and the second fixture portion are respectively formed as a mesh, a flat plate cover, a mold, or a flat plate-shaped frame.

8. An automated displacement and turnover system comprising the automated displacement and turnover device as claimed in claim 1, and a terminal device and/or a mobile terminal; wherein:
the automated displacement and turnover device comprises a device body and a processing fixture installed on the device body;
the terminal device and the mobile terminal are used to connect to the device body through communication, and a control module is provided to control and drive the device body to perform linear displacement and fixed-point turnover functions in preset mode.

9. The automated displacement and turnover system as claimed in claim 8, wherein communication connection between the automated displacement and turnover device and the terminal device and the mobile terminal comprises wired communication connection and wireless communication connection.

10. The automated displacement and turnover system as claimed in claim 8, wherein the power source of the automated displacement and turnover device connects to the terminal device and the mobile terminal via an intelligent control module through communication.

11. An automated displacement and turnover system comprising the automated displacement and turnover device as claimed in claim 2, and a terminal device and/or a mobile terminal; wherein:
the automated displacement and turnover device comprises a device body and a processing fixture installed on the device body;
the terminal device and the mobile terminal are used to connect to the device body through communication, and a control module is provided to control and drive the device body to perform linear displacement and fixed-point turnover functions in preset mode.

12. The automated displacement and turnover system as claimed in claim 11, wherein communication connection between the automated displacement and turnover device and the terminal device and the mobile terminal comprises wired communication connection and wireless communication connection.

13. The automated displacement and turnover system as claimed in claim 11, wherein the power source of the automated displacement and turnover device connects to the terminal device and the mobile terminal via an intelligent control module through communication.

14. An automated displacement and turnover system comprising the automated displacement and turnover device as claimed in claim 3, and a terminal device and/or a mobile terminal; wherein:
the automated displacement and turnover device comprises a device body and a processing fixture installed on the device body;
the terminal device and the mobile terminal are used to connect to the device body through communication, and a control module is provided to control and drive the device body to perform linear displacement and fixed-point turnover functions in preset mode.

15. The automated displacement and turnover system as claimed in claim 14, wherein communication connection between the automated displacement and turnover device and the terminal device and the mobile terminal comprises wired communication connection and wireless communication connection.

16. The automated displacement and turnover system as claimed in claim 14, wherein the power source of the automated displacement and turnover device connects to the terminal device and the mobile terminal via an intelligent control module through communication.

17. An automated displacement and turnover system comprising the automated displacement and turnover device as claimed in claim 4, and a terminal device and/or a mobile terminal; wherein:
the automated displacement and turnover device comprises a device body and a processing fixture installed on the device body;
the terminal device and the mobile terminal are used to connect to the device body through communication, and a control module is provided to control and drive the device body to perform linear displacement and fixed-point turnover functions in preset mode.

18. The automated displacement and turnover system as claimed in claim 17, wherein communication connection between the automated displacement and turnover device and the terminal device and the mobile terminal comprises wired communication connection and wireless communication connection.

19. The automated displacement and turnover system as claimed in claim 17, wherein the power source of the automated displacement and turnover device connects to the terminal device and the mobile terminal via an intelligent control module through communication.
